(19) United States
(12) Patent Application Publication
(10) Pub. No.: US 2006/0232034 A1
(43) Pub. Date: Oct. 19, 2006

(54) Furniture cart

(76) Inventor: Charles T. Skiles, Mineral Point, MO (US)

Correspondence Address: Paul M. Denk, Ste. 170, 763 S. New Ballas Road, St. Louis, MO, 63141, US

(21) Appl. No.: 11/389,694

(22) Filed: Mar. 27, 2006

Related U.S. Application Data
(60) Provisional application No. 60/672,767, filed on Apr. 19, 2005.

(51) Int. Cl. B62B 1/00

(52) U.S. Cl. 280/79.2

(57) ABSTRACT

The furniture cart adjusts in height and supports lengthy furniture above ground level. The furniture cart has two parallel bars of sufficient length to support a sofa. The bars have stems that insert into legs for height adjustment with the stems temporarily secured by pins. The legs join to plates with casters beneath the plates. Upon one end, each bar has a handle to direct the furniture cart while in use to move sofas and other large furniture above other furniture, and when moving sofas at the elevation of waiting trucks.

### CROSS REFERENCE TO RELATED APPLICATION

This nonprovisional patent application claims priority to the provisional patent application having Ser. No. 60/672,767, which was filed on Apr. 19, 2005.

### BACKGROUND OF THE INVENTION

This furniture cart relates to material handling equipment and more specifically to wheeled carts. A unique aspect of the present cart is a pair of bars suitable for supporting lengthy furniture above the ground.

Dollys and carts have been used for decades for moving furniture to and from trucks, into buildings, and around showrooms. Dollys have a flat deck with three or more wheels beneath the deck. A dolly typically has an overall height less than one foot. In use, cargo or furniture is tilted from one edge and the dolly pushed under the furniture. The furniture is then lowered upon the dolly. A person leans on the furniture to move the dolly, carrying the furniture, as desired. Dollys see regular use moving sofas, couches, and heavy cabinets. Then trucks or carts have handles for a person to grasp while standing, a deck or a plate to support cargo or furniture, and two or more wheels near the deck. In use, a cart is placed adjacent to furniture. The furniture is tilted upon one edge and the deck is inserted beneath the furniture. After lowering the furniture upon the deck, the furniture is pushed towards the cart and the cart is tilted. Grasping the handles, a person tilts the cart upon the wheels and moves the furniture to a desired location. Carts see regular use moving filing cabinets, small tables, and chairs. However, dollys and carts move furniture generally at ground level. At that level, dollys and carts encounter obstacles, such as other furniture, in a showroom.

The present art overcomes the limitations of the prior art. That is, in the art of the present invention, a pair of bars raised above ground level support furniture placed upon the bars. The bars have a height above the typical sofa and thus furniture placed upon the bars can be moved around a showroom with less risk of collision.

The difficulty in providing an upholstered furniture cart is shown by the operation of other carts. The patent to Neville et al, U.S. Pat. No. 864,680, shows an automobile truck, in the form of a cart, with casters, and which may support a very early automobile thereon, for the convenience of moving the automobile within and around a garage for repair purposes. This patent shows the use of a wheeled cart, for supporting and transferring a load within a specific environment.

The patent to Smith et al, U.S. Pat. No. 2,436,337, shows a gantry structure that incorporates an upper bridging member. In this patent, the bridging member is an I beam that can support a conventional hoist 13, for lifting purposes, markedly different from the present invention.

The patent to Schultz, U.S. Pat. No. 2,604,334, shows a clothes cart having a vertically adjustable platform. This is a cart used in moving clothing particularly during cleaning and pressing. Similar to the present invention, this cart has casters for moving items.

The Boat Dolly to Weinstein, U.S. Pat. No. 5,000,468, shows a dolly for transporting a boat. This wheeled dolly can be loaded and then tilted up, for shifting a boat to other locations. The claims in this patent define a dolly for raising and moving a boat, quite different from the present invention.

The patent to Sperko, U.S. Pat. No. 5,072,960, shows a sterilizer cart, and not the intended usage of the present invention. Furthermore, the claims of this patent, define a very specific cart that does not have the structure of the present invention. For example, the cart described in claim 1 calls for a pair of rails, mounted on a frame, having movable casters, but further requires the use of a detent member which comprises a pair of arcuate ends. The specification does not describe exactly where these arcuate ends are involved, but probably these would be the V shaped members 27 that are provided at least at one end of the shown cart. The present invention does not have the interrelationship of these components.

The patent to Agopian, U.S. Pat. No. 5,503,424, shows a collapsible utility cart apparatus. The present invention does not include any type of a first frame, with a second frame, which can be locked together, or where one may be collapsed within the other, as shown in this patent.

The patent to Johnson, U.S. Pat. No. 5,788,251, shows a table lift and transporter. Once again, this patent shows a type of cart, but generally identified as a lift and transporter assembly. This patent has far more structure than the present invention.

The patent to Oefelein et al, U.S. Pat. No. 6,036,219, shows an expandable transport cart. The expansion feature generally provides for the extension upwardly of the shown material panels 48 to embrace the items placed upon the tube assemblies 12 forming the face of the shown cart. In contrast, the present invention does not have all the structure as defined in this particular patent.

The patent to Haley, U.S. Pat. No. 6,131,929, shows a portable modular cart and game table. This particular cart is far more complex than the present invention and is used for an entirely different purpose. The claims call for a combination beverage cart and game table.

The patent to Skinner, U.S. Pat. No. 6,296,262, shows a table cart for holding a plurality of folding tables. But, the present invention does not store folding tables.

The patent to Smith, U.S. Pat. No. 6,802,525, shows a pivotal handle for a food service table. The present invention is not a food service table, and does not include any type of pivotal handle.

Two published applications relate to the present invention. One is publication No. US 2003/0164602, upon the invention of Kuhlman, identified as a table cart. Again, this a form of cart used for transporting a plurality of folding tables. The claims of this application specifically define that the cart frame includes a top frame having an open side but this is not the structure of the present invention.

Another published application to Sorenson, No US 2004/0256819, is upon a power train handler. This type of a handler is a form of cart, but is normally used for the removal and installation of the power train for a motor vehicle, as in an assembly plant. This is not the structure, nor the intended usage, of the present invention.

The present invention overcomes the difficulties of the prior art. The prior art has carts for moving a plurality of objects: automobiles, boats, laundry, folding chairs, and mechanical powertrains. The prior art teaches away from a cart to move furniture. Though having wheels, the present invention has upright legs to permit telescoping of the ends of the bars. The bars can then be raised and lowered as needed. The bars have sufficient length to support a sofa or couch of regular size.

### SUMMARY OF THE INVENTION

The furniture cart is a device, adjustable in height, that supports lengthy furniture raised above ground level. The furniture cart has two parallel bars of sufficient length to support a sofa. The bars have stems at each end that insert into legs. The stems permit adjusting the height of the furniture cart. The legs join to plates opposite the bars. Casters depend beneath the plates also opposite the legs. Each side of the furniture cart has two or more casters. Upon one end of the bars, each bar has a handle to assist in directing the furniture cart while in use. The furniture cart sees use inside a furniture showroom to move sofas and other large furniture above other furniture. Outside a furniture showroom, the furniture cart transports sofas at the elevation of waiting trucks.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

Therefore, it is an object of the present invention to provide a new and improved furniture cart.

It is a further object of the present invention to provide a furniture cart for sofas and lengthy furniture.

It is a still further object of the present invention to provide a furniture cart that adjusts in height.

These and other objects may become more apparent to those skilled in the art upon review of the invention as described herein, and upon undertaking a study of the description of its preferred embodiment, when viewed in conjunction with the drawings.

### BRIEF DESCRIPTION OF THE DRAWINGS

FIG. 1 is an isometric view of the preferred embodiment constructed in accordance with the present invention;

FIG. 2 shows a front exploded view of the present invention;

FIG. 3 shows a top view of the present invention;

FIG. 4 describes a side view of the present invention;

FIG. 5 illustrates the present invention in use in a showroom; and,

FIG. 6 illustrates the present invention in use during loading of a truck.

The same reference numerals refer to the same parts throughout the various figures.

### DESCRIPTION OF THE PREFERRED EMBODIMENT

The present art overcomes the prior art limitations by providing a furniture cart that adjusts in height and has a length to support a sofa. Turning to FIG. 1, the present invention 1 has two parallel bars 3 of sufficient length that support a sofa. The bars 3 are mutually parallel and spaced apart. Each bar 3 has two opposite ends that connect with legs 6. Upon one end of the bars 3, handles 11 extend parallel to the bars 3 and perpendicular to the legs 6. The legs 6 are upright and slightly larger in width than the bars 3. Each pair of legs 6 are mutually parallel and spaced apart, and denote a side of the present invention 1. Each pair of legs 6 joins to a plate 7 opposite the bars 3. Each plate 7 has a generally planar shape and maintains the spacing of the legs 6 and the bars 3. In the preferred embodiment, the plate 7 has a rectangular shape. Beneath each plate 7, the present invention 1 has two casters 8 that move the invention 1 and furniture 2 upon it.

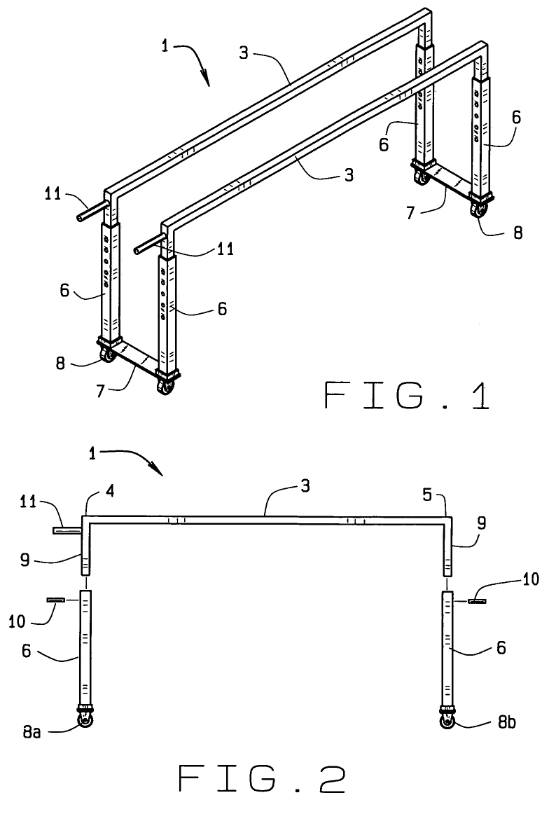

Showing a side and exploded view of the invention, FIG. 2 illustrates one of the bars 3 and its ends. Upon both ends 4, 5, the bar 3 has stems 9 depending beneath the bar 3. The stems 9 have a shape complementary and slightly smaller in cross section than the legs 6. The stems 9 nest within the legs 6 for adjusting the height of the bar 3 through telescoping action. Upon the left end 4, the bar 3 has a handle 11 extending parallel to the bar 3 and perpendicular to the stem 9. In the preferred embodiment, the handle 11 is below the bar 3 to assist in grasping the handle 11 when furniture is loaded upon the present invention 1. Upon the right end 5 opposite the left end 4, the bar 3 lacks any handle. Beneath the plate 7 upon the right end 5, the preferred embodiment has fixed casters 8b oriented parallel to the bars 3. Then beneath the plate 7 upon the left end 4, the casters 8a swivel to orient the preferred embodiment of the present invention 1 in a desired direction of movement. In the preferred embodiment, the bars 3 and the legs 6 are tubular square shaped members.

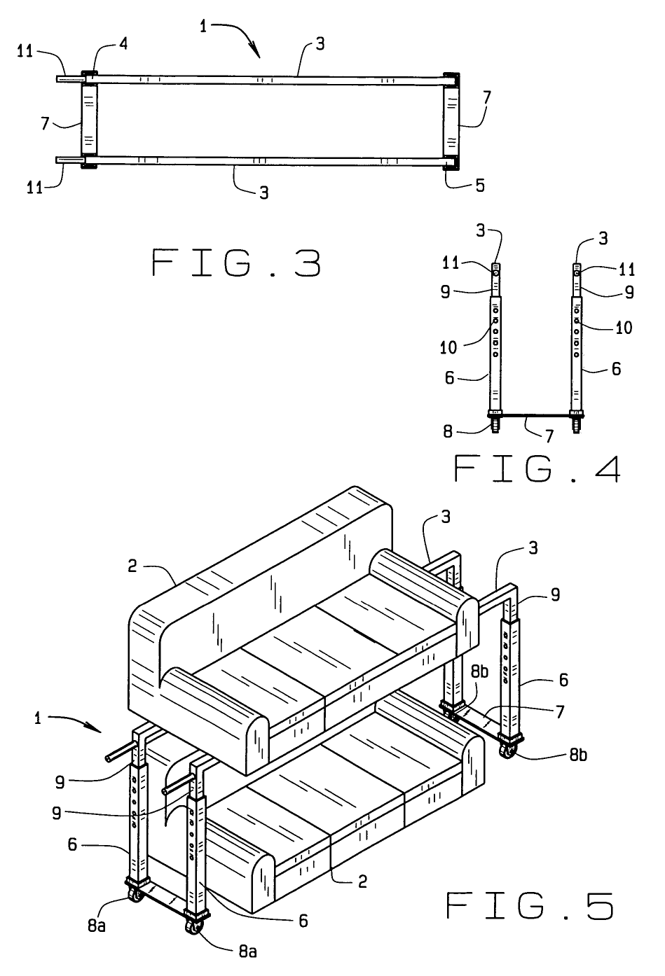

As in FIG. 1, the bars 3 are mutually parallel and spaced apart in FIG. 3. The bars 3 are spaced apart a sufficient distance to support a sofa 2 placed upon them, yet narrow enough to maneuver in a furniture showroom. The narrow width of the present invention 1 permits travel between adjacent pieces of furniture or above furniture as later shown in FIG. 5. As before, handles 11 extend from the left ends 4 of the bars 3 and plates 7 support the pairs of legs 6 upon each end of the present invention 1.

FIG. 4 describes the left side of the present invention 1. The left side has a handle 11 extending from the stem 9 of each bar 3. But for the handles 11, the right side is similar to the left side. The left side has two swivel casters 8a beneath a plate 7 whereas the right side has two fixed casters 8b. The casters 8 on both sides are located beneath the legs 6. The legs 6 extend perpendicular to the horizontal plate 7, generally near the front and rear ends of the plate 7. The legs 6 extend upward at least half of the maximum height for the present invention 1. Opposite the plate 7, each leg 6 admits a stem 9 of a bar 3. The stem 9 telescopes within the leg 6. In the preferred embodiment, each leg 6 and each stem 9 have a pattern of holes that admit a pin 10 when aligned. The holes and pins 10 permit adjusting the elevation of the present invention 1.

Generally, the stems 9 are extended out from the legs 6 so that the present invention 1 passes over furniture 2 along a chosen route in a showroom. FIG. 5 shows the present invention 1 in use with the stems 9 extended as the present invention 1 passes over another piece of furniture 2. In use, the present invention 1 is positioned near the furniture to be moved, such as a sofa 2. The pins 10 are then pulled from the legs 6 and the stems 9 raised upward to a desired height. Here in FIG. 5, the desired height is the elevation of the other piece of furniture 2. With the stems 9 and bars 3 near or above the desired height, the pins 10 are inserted through the legs 6 and their respective stems 9, temporarily locking the present invention 1 at the desired height. The staff then lifts a piece of furniture 2 on to the bars 3, generally centering the furniture 2 upon the bars 3, both side to side and front to back. The raised furniture 2 can then be moved through a showroom, above the other furniture 2.

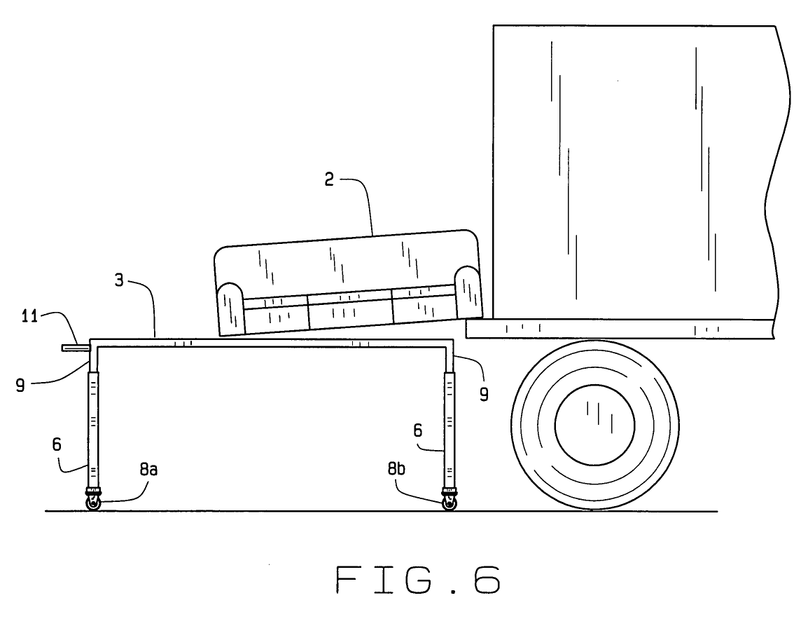

In time, a piece of furniture sells or has to be moved out of the showroom as shown in FIG. 6. The present invention 1 can be adjusted in height to meet the loading height of a truck prior to lifting furniture 2 upon the bars 3. With the present invention 1 set at a height to clear other furniture, the present invention 1 elevates the piece of furniture 2 to the loading height of a truck, here shown in the right of this figure. For loading of a truck, the present invention 1, with a load of furniture, is moved adjacent to the back of a truck. There, furniture 2 can be pushed off the present invention 1 and into a truck. Unloaded, the empty furniture cart 1 is returned to the showroom for another load of furniture.

From the aforementioned description, a furniture cart has been described. The furniture cart is uniquely capable of adjusting in height and carrying lengthy furniture raised above a floor. The furniture cart and its various components may be manufactured from many materials, including but not limited to steel, polymers, polyethylene, polypropylene, polyvinyl chloride, nylon, ferrous and non-ferrous metals and their alloys, and composites.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A device having a narrow configuration and dimension and for use for transporting furniture above the ground and through very tight and congested condition, such as in a furniture showroom, comprising:
two or more bars each having two opposite ends, a left end and a right end;
two or more legs upon each of said ends of each of said bars, said legs being perpendicular to said bar;
two or more plates locating beneath each pair of legs and opposite said bars; and,
two or more casters locating beneath each of said plates.

2. The furniture transporting device of claim 1 further comprising:
two of said bars, mutually parallel and spaced apart, having mutually parallel stems depending beneath each end and perpendicular to said bars;
four of said legs, said stems inserting into said legs;
said plate beneath the left end of said bars having said casters swivel; and,
said plate beneath the right end of said bars having said casters being fixed.

3. The furniture transporting device of claim 2 wherein said stems nest within said legs opposite said plates.

4. The furniture transporting device of claim 3 further comprising:
said stems and said legs having complementary patterns of holes; and,
one or more pins cooperating with each of said stems and said legs respectively and inserting into two aligned holes to secure temporarily said bar at a desired height above the ground.

5. The furniture transporting device of claim 3 further comprising:
one or more handles upon said stems parallel to said bars.

6. The furniture transporting device of claim 2 wherein the legs have a height for orienting for the two bars level with the back end of any truck to be loaded or unloaded with any furniture and to facilitate its application for removal from any truck during usage.

7. The furniture transporting device of claim 2 wherein each pair of legs at the end of two of said bars being spaced relatively close together, to facilitate the transit of furniture through any narrow aisles in a furniture showroom during usage.
